(19) United States
(12) Patent Application Publication
(10) Pub. No.: US 2005/0061522 A1
(43) Pub. Date: Mar. 24, 2005

(54) Piston rod rotary driving device of screw nail gun

(76) Inventor: Yun-Chung Lee, Taipei (TW)

Correspondence Address: Yun-Chung Lee, 235 Chung-Ho, Box 8-24, Taipei, TW

(21) Appl. No.: 10/666,783

(22) Filed: Sep. 22, 2003

(51) Int. Cl. B23Q 5/00

(52) U.S. Cl. 173/145

(57) ABSTRACT

A piston rod rotary driving device of a screw nail gun is disclosed. The structure is installed in a gun head of the screw nail gun. The gun head comprises at least one pneumatic motor; a cylinder; a piston rod in the cylinder; one end of the piston rod having a piston. A spindle of the pneumatic motor is installed with a rod groove for receiving the piston rod; and the spindle of the pneumatic motor drives the output disk to rotate. A plurality of polygonal supporting holes are installed at a center portion of the output disk. The piston rod is a polygonal rod so that the piston rod can be coupled to the supporting holes to move therein; and the output disk drives the piston to rotate. Thus, before pressing the trigger, the piston rod is compressed to received in the pneumatic motor so as to reduce the size of the gun head effectively.

### FIELD OF THE INVENTION

The present invention relates to screw nail guns, and particularly to a piston rod rotary driving device of a screw nail gun, wherein a rod groove is formed on the spindle of the pneumatic motor for receiving the piston rod. An output disk for installing the pneumatic motor serves to drive the polygonal piston rod to further drive a screw nail so that the screw nail moves linearly.

### BACKGROUND OF THE INVENTION

The pneumatic screw nail gun is actuated by high pressure air to drive a piston rod in the gun head so as to trigger a screw nail to move linearly. Thereby, the pneumatic motor is driven to drive the piston rod to rotate for locking the nail. When the piston rod in the gun head is triggered, the piston rod presses forward to rotate the screw nail.

Above application is disclosed in Japan Patent Laid open No. 11-300639. In the prior art, a cylinder is installed in the gun head, a piston is in the cylinder and a piston rod connected to the piston. A pneumatic motor is installed above the piston rod. The prior art further discloses that the spindle of the pneumatic motor is connected to a planet gear set for speed reduction and increasing the output twisting force. The planet gear set will drive a rotation cylinder to rotate. An inner wall of the rotating cylinder has a groove for receiving and driving a rotation body on the piston rod so as to drive the piston rod to rotate therewith.

However above mentioned prior art has some defect, especially, the driving structure is realized by using a rotation cylinder to drive the piston rod to rotate. This will cause that the rotation cylinder has a larger guiding height. Thereby, in the traveling process as the piston rod presses downwards and triggers the trigger, the rotation body on the piston rod is guided in the whole process so as to drive the piston rod to rotate to fix the nail. Therefore the height of the piston rod must be slightly larger than the traveling length of the piston rod. It is known that the rotation cylinder is placed connected the pneumatic motor and the cylinder and thus the gun head must has a larger volume for receiving the rotation cylinder. This will induce a heavy gun head and the operation is inconvenient. Thus, the prior art screw nail gun is necessary to be improved for overcoming above said defect.

### SUMMARY OF THE INVENTION

Accordingly, the primary object of the present invention is to provide a piston rod rotary driving device of a screw nail gun, wherein the height of the gun head of the screw nail gun is reduced effectively.

To achieve above object, in the present invention, the piston rod is hidden in the spindle of the pneumatic motor so as to reduce the distance between the cylinder and the pneumatic motor so as to reduce the height of the gun head effectively.

Furthermore, the rotation dynamic power of the pneumatic motor is transferred to an output disk. The height of the output disk is farther smaller than the prior art rotation cylinder so that the piston rod can be pressed in the center of the output disk to reduce the volume and height of the driving structure in the gun head. Thus the volume and height of the gun head can be reduced effectively.

The piston rod is a polygonal rod and the output disk or the components thereof has a polygonal supporting hole in the center thereof. Thereby, the output disk is engaged to the piston rod directly. The prior art rotation body and rotation cylinder are unnecessary. Thereby, the height of the gun head is reduced effectively.

To achieve above object, the present invention provide a piston rod rotary driving device of a screw nail gun. The structure is installed in a gun head of the screw nail gun. The gun head comprises at least one pneumatic motor; a cylinder; a piston rod in the cylinder; one end of the piston rod having a piston. A spindle of the pneumatic motor is installed with a rod groove for receiving the piston rod; and the spindle of the pneumatic motor drives the output disk to rotate. A plurality of polygonal supporting holes are installed at a center portion of the output disk. The piston rod is a polygonal rod so that the piston rod can be coupled to the supporting holes to move therein; and the output disk drives the piston to rotate.

The various objects and advantages of the present invention will be more readily understood from the following detailed description when read in conjunction with the appended drawing.

### BRIEF DESCRIPTION OF THE DRAWINGS

FIG. 1 is a perspective view of the screw nail gun of the present invention,

FIG. 2 is a schematic view about the screw nail gun of the present invention.

FIG. 3 is a cross section view along line 3a-3a of FIG. 2.

FIG. 4 is a cross section view along line 4a-4a of FIG. 2.

FIG. 5 is a cross section view along line 5a-5a of FIG. 2.

FIG. 6 is a cross section view showing the triggering state of the piston rod in the screw nail gun of the present invention.

### DETAILED DESCRIPTION OF THE PREFERRED EMBODIMENTS

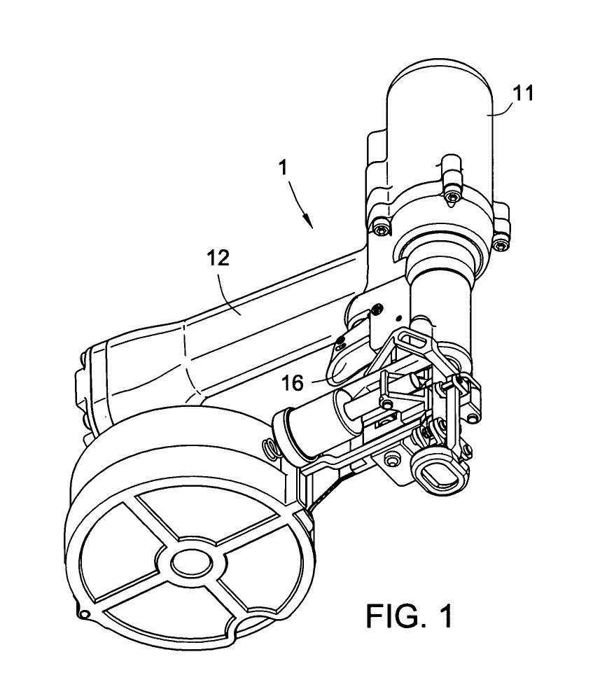

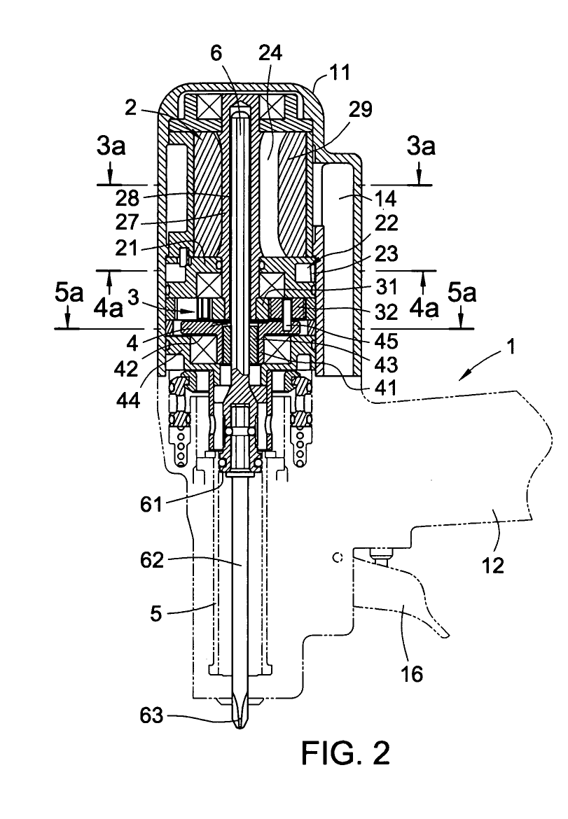

Referring to FIG. 1, the screw nail gun of the present invention is illustrated. The screw nail gun has a gun body 1. The gun body 1 includes a gun head 11 and a handle 12. A trigger 16 is installed between the handle 12 and the gun head 11. Referring to FIG. 2, it is shown that the rotary driven means of the piston rod 6 of the gun head 11 includes a pneumatic motor 2, a planet gear set 3, a output disk 4, a cylinder 5 and the piston rod 6 to be driven.

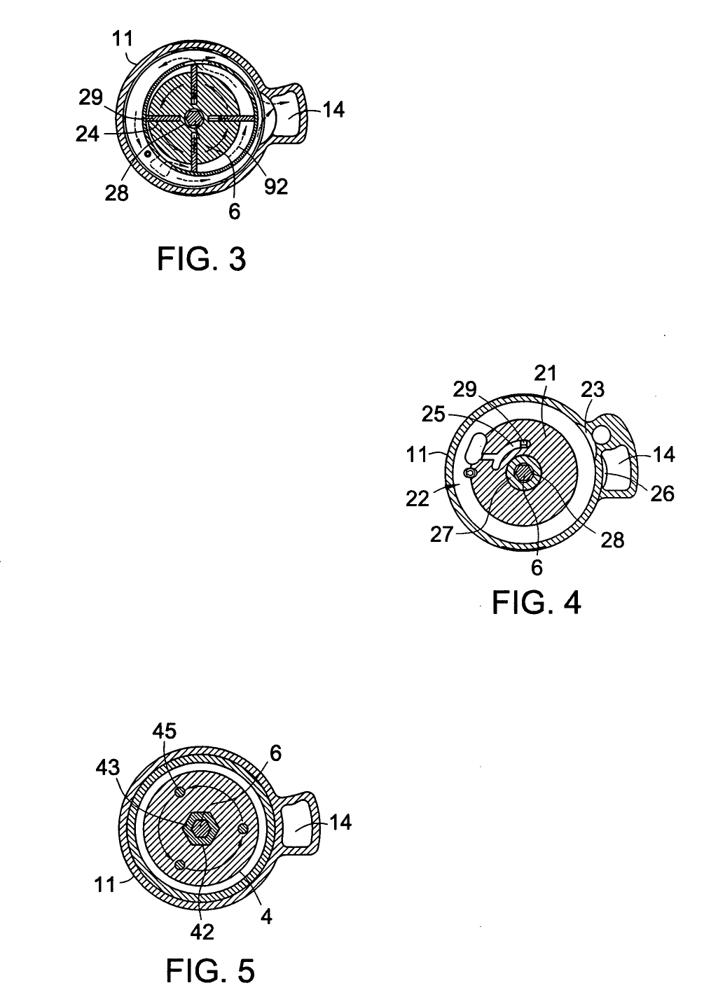

The pneumatic motor 2 has a central spindle 27 (referring to FIG. 2). A center of the spindle 27 has a rod groove 28. The pneumatic motor 2 has a plurality of blade receiving tanks 24 which are arranged as a radiating form (referring to FIG. 4). One side of the air inlet chamber 22 has an air inlet 23. The air inlet chamber 22 further has a booster opening 25 at a position communicated to the bottom of the blade receiving tank 24 of the pneumatic motor 2. One side wall of the pneumatic motor 2 is formed with an exhausting opening 26 which is communicated with an exhausting channel 14. The exhausting channel 14 is connected to the handle 12 and thus is communicated with outside. Thereby, the pneumatic motor 2 can be actuated to rotate by the high pressure air 92 in the gun body 1 (referring to FIG. 3).

The planet gear set is formed by a driving gear 31 and a plurality of driven gears 32 (referring to FIG. 2). The driving gear 31 is firmly secured to a distal end of the spindle 27 of the pneumatic motor 2. Thus, the plurality of driven gears 32 are driven by the driving gear 31 to rotate around the driving gear 31.

A neck portion 41 extends downwards from the output disk 4. The neck portion 41 is pivotally installed to a bearing seat 44. A center of the output disk 4 is formed with a polygonal support hole 42 (referring to FIG. 5). A bush 43 having a shape like the supporting hole 42 is placed in the supporting hole 42 so as to receive the polygonal piston rod 6. Thereby, the piston rod 6 can move in the bush 43. A plurality of pivotal shafts 45 are pivotally installed on a disk surface of the output disk 4. Another end of the pivotal shafts 45 are pivotally installed to the driven gears 32 of the planet gear set 3 (referring to FIG. 2). The number of the pivotal shafts 45 is equal to that of the driven gears 32. Thus, the output disk 4 can be driven by the planet gear set 3 to rotate and thus to drive the piston rod 6 to rotate.

It is possible that no bush 43 is installed in the output disk 4. The polygonal supporting hole 42 directly drive the polygonal piston rod 6 to rotate and the piston rod 6 moves in the supporting hole 42.

The piston rod 6 has a polygonal rod wall. One end thereof is movably installed to the rod groove 28 of the pneumatic motor 2, and another end thereof is formed with a piston 61. The piston 61 is movable installed to the cylinder 5. A bottom of the piston 61 is embedded with a nail locking rod 62. One end of the nail locking rod 62 is formed with a cruciform portion 63 which can be engaged with a cruciform slot of a screw nail 9 (referring to FIG. 2) so that the piston rod 6 can trigger the screw nail to move linearly by the action of the high pressure air 92 in the cylinder 61.

The polygonal walls of the piston rod 6 and supporting hole 42, or piston rod 6 and bush 43 may be one of a triangular shape, rectangular shape, hexagonal shape, etc., so that they are engaged to rotate or move with respect to one another.

By above components, when the trigger 16 is not pressed (referring to FIG. 2), the piston rod 6 is compressed in the central rod groove 28 of the pneumatic motor 2.

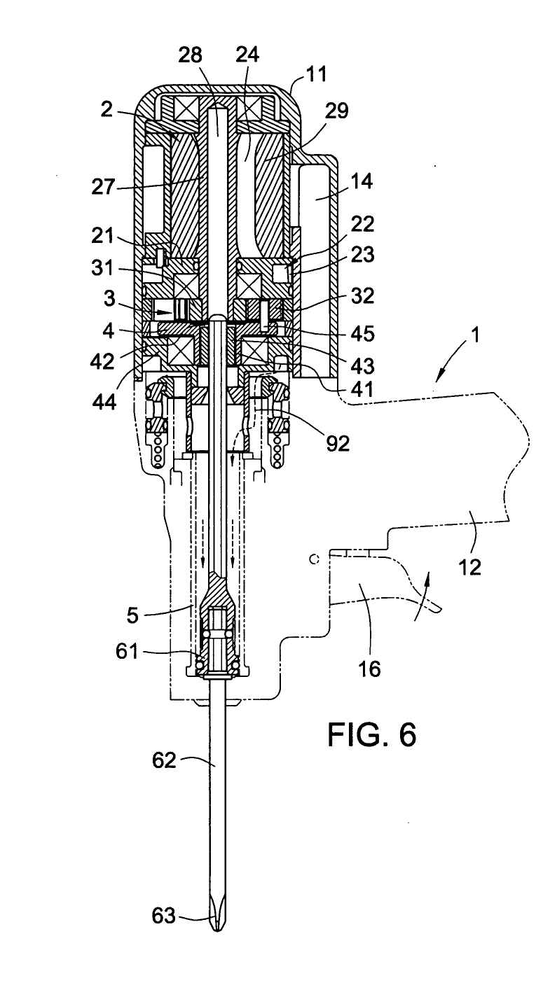

When the trigger 16 is triggered (referring to FIG. 6), the high pressure air 92 in the gun body 1 is loaded to the pneumatic motor 2 and the plurality of blades 29 are rotated continuously (referring to FIG. 3) for driving the spindle 27 to output rotation dynamic power. Then by the speed reduction and the increment of twisting force of the planet gear set 3, the output disk 4 rotates steadily so as to drive the piston rod 6 to rotate.

When the user uses the trigger (referring to FIG. 6), the high pressure air 92 in the gun body 1 moves into the cylinder 5 with the air to push the piston 61 to displace linearly so that the piston rod 6 can move in the supporting hole 42 at the same time. Thus the screw nail rotates to lock the screw.

It is known from above description that in the present invention, before pressing the trigger 16, the piston rod 6 is compressed to be received in the pneumatic motor 2 so as to reduce the distance between the cylinder 5 and the pneumatic motor 2 effectively. Furthermore, the space for the output disk 4 to drive the piston rod 6 to rotate is small. Thus, the volume and height of the rotary driven structure in the gun head 11 are finite.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-5. (Cancelled)

6. A piston rod rotary driving device of a screw nail gun; the driving device being installed in a gun head of the screw nail gun;
at least one pneumatic motor installed in one end portion of the gun head; the at least one pneumatic motor being capable of being driven by high pressure air,
a cylinder capable of loading high pressure air;
a piston rod in the cylinder, one end of the piston rod having a piston; the piston being actuated by the high pressure air so as to trigger a screw nail to move linearly; another end of the piston rod being driven by the pneumatic motor to rotate the screw nail;
a spindle of the pneumatic motor formed with a rod groove for receiving the piston rod; and the spindle of the pneumatic motor driving an output disk to rotate; the spindle being connected to the piston rod; the piston rod being capable of receiving a nail locking rod for driving a nail;
a polygonal supporting hole being formed at a center portion of the output disk; the piston rod being a polygonal rod so that the piston rod can be coupled to the supporting holes to move therein; and the output disk drives the piston to rotate;
wherein a planet gear set is installed between the spindle of the pneumatic motor and the output disk for transferring rotation power;
wherein the planet gear set is formed by a driving gear and a plurality of driven gears; the driving gear is firmly secured to a distal end of the spindle of the pneumatic motor; and the driven gears are pivotally installed on the disk surface of the output disk; the plurality of driven gears are arranged around the driving gear and are driven by the driving gear so as to further drive the output disk to rotate;
wherein the output disk is pivotally installed to a bearing seat;
wherein a bush with a shape identical to that of the supporting hole is installed in the supporting hole so as to install the piston rod in the bush; the piston rod is movable in the bush.
